(19) United States
(12) Patent Application Publication
(10) Pub. No.: US 2025/0151929 A1
(43) Pub. Date: May 15, 2025

(54) PRODUCT HOLDER SYSTEMS AND METHODS OF FORMING THE SAME

(71) Applicant: iSee Store Innovations, L.L.C., St. Louis, MO (US)

(72) Inventors: Steven Allen Brenner, St. Louis, MO (US); Vikas Varma Alluri, Hazelwood, MO (US); Frank Shannon, Gangkou Town, Zhongshan (CN)

(73) Assignee: iSee Store Innovations, L.L.C., St. Louis, MO (US)

(21) Appl. No.: 18/925,211

(22) Filed: Oct. 24, 2024

Related U.S. Application Data
(60) Provisional application No. 63/597,376, filed on Nov. 9, 2023.

(51) Int. Cl. A47F 5/11; B32B 3/06; B32B 5/18; B32B 27/06; B32B 27/30; B32B 37/12

(52) U.S. Cl. CPC A47F 5/116; B32B 3/06; B32B 5/18; B32B 27/065; B32B 27/304; B32B 37/12; B32B 2250/03; B32B 2250/40; B32B 2255/10; B32B 2305/022; B32B 2307/4023; B32B 2327/06; B32B 2607/00

(57) ABSTRACT

A board is configured to form one or more portions of a product holder system. The board includes a first exterior polyvinyl chloride (PVC) layer, a second exterior PVC layer, and an interior foam layer having a first surface and a second surface opposite from the first surface. The first PVC layer is coupled to the first surface. The second PVC layer is coupled to the second surface.

### CROSS-REFERENCE TO RELATED APPLICATIONS

This application is a non-provisional conversion of, and claims priority to, U.S. Provisional Patent Application No. 63/597,376, filed Nov. 9, 2023, which is incorporated by reference in its entirety.

### FIELD OF THE DISCLOSURE

Examples of the present disclosure generally relate to product holder systems, and methods of forming product holder systems.

### BACKGROUND OF THE DISCLOSURE

Various commercial enterprises offer goods for sale that may be supported on or in a display structure. However, such structures can be formed from materials that may not be easily formed and shipped.

Also, certain structures are formed from panels that need to be heated and/or treated to prevent cracking and damage, which increases manufacturing time and costs. As another example, corrugated sheets can be damaged by water, and may not be strong enough to support certain items.

### SUMMARY OF THE DISCLOSURE

A need exists for an improved method of forming a product display structure. Further, a need exists for a resilient and robust product display structure. Additionally, a need exists for a product display structure that is impervious to water.

With those needs in mind, certain examples of the present disclosure provide a board configured to form one or more portions of a product holder system. The board includes a first exterior polyvinyl chloride (PVC) layer, a second exterior PVC layer, and an interior foam layer having a first surface and a second surface opposite from the first surface. The first PVC layer is coupled to the first surface. The second PVC layer is coupled to the second surface.

In at least one example, the first PVC layer is adhesively secured to the first surface, and the second PVC layer is adhesive secured to the second surface.

In at least one example, the board is configured to be formed as a flat panel.

The board can be cut, sized, shaped, and folded to form the one or more portions of the product holder system. In a further example, the board is cut, sized, shaped, and folded without being heated. Further, none of the first exterior PVC layer, the second exterior PVC layer, or the interior foam layer is corrugated.

In at least one example, one or both of the first exterior PVC layer or the second exterior PVC layer includes one or both of text or graphics printed thereon.

In at least one example, the board includes one or more walls, tabs, and slots. The one or more walls and the tabs include the first exterior PVC layer, the second exterior PVC layer, and the interior foam layer.

The board can include a near field communication device secured to the interior foam layer. The board can include a nut secured to the interior foam layer.

Certain examples of the present disclosure provide a method of forming a product holder system. The method includes coupling a first exterior polyvinyl (PVC) layer to a first surface of an interior foam layer; coupling a second exterior PVC layer to a second surface of the interior foam layer, wherein the second surface is opposite from the first surface; forming a board by the first PVC layer and the second PVC layer coupled to the interior foam layer; and forming one or more portions of the product holder system with the board.

In at least one example, said coupling the first PVC layer includes adhesively securing the first PVC layer to the first surface, and said coupling the second PVC layer comprises adhesively securing the second PVC layer to the second surface.

In at least one example, said forming the board includes forming the board as a flat panel.

In at least one example, the method further includes cutting, sizing, shaping, and folding the board to form the one or more portions of the product holder system. As a further example, said cutting, sizing, shaping, and folding occurs without heating.

The method can also include printing one or both of text or graphics on one or both of the first exterior PVC layer or the second exterior PVC layer.

Certain examples of the present disclosure provide a product holder system including one or more shelves formed by one or more boards, as described herein.

### BRIEF DESCRIPTION OF THE DRAWINGS

FIG. 1 illustrates a box diagram of a board, according to an example of the present disclosure.

FIG. 2 illustrates an isometric front view of a wall panel, according to an example of the present disclosure.

FIG. 3 illustrates an isometric front exploded view of a product holder system, according to an example of the present disclosure.

FIG. 4 illustrates an isometric front exploded view of a wall panel and a shelf panel, according to an example of the present disclosure.

FIG. 5 illustrates an isometric front exploded view of a retaining shroud separated from the shelf panel, according to an example of the present disclosure.

FIG. 6 illustrates an isometric front exploded view of inwardly-bent tabs of the retaining shroud, according to an example of the present disclosure.

FIG. 7 illustrates an isometric front view of the shelf panel connecting to the retaining shroud, according to an example of the present disclosure.

FIG. 8 illustrates an isometric front view of the shelf panel having a front portion upwardly folded, according to an example of the present disclosure.

FIG. 9 illustrates an isometric front view of the shelf panel having a top portion rearwardly folded, according to an example of the present disclosure.

FIG. 10 illustrates an isometric front view of a product holder system, according to an example of the present disclosure.

FIG. 11 illustrates an isometric front view of product holder systems, according to examples of the present disclosure.

FIG. 12 illustrates an isometric front view of product holder systems, according to examples of the present disclosure.

FIG. 13 illustrates an isometric top view of a base, according to an example of the present disclosure.

FIG. 14 illustrates an isometric top exploded view of the base of FIG. 13.

FIG. 15 illustrates an isometric front view of product holder systems retaining products, according to an example of the present disclosure.

FIG. 16 illustrates an isometric exploded view of a board, according to an example of the present disclosure.

FIG. 17 illustrates an isometric view of the board of FIG. 16.

FIG. 18 illustrates an isometric exploded view of a board, according to an example of the present disclosure.

FIG. 19 illustrates an isometric view of the board of FIG. 18.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

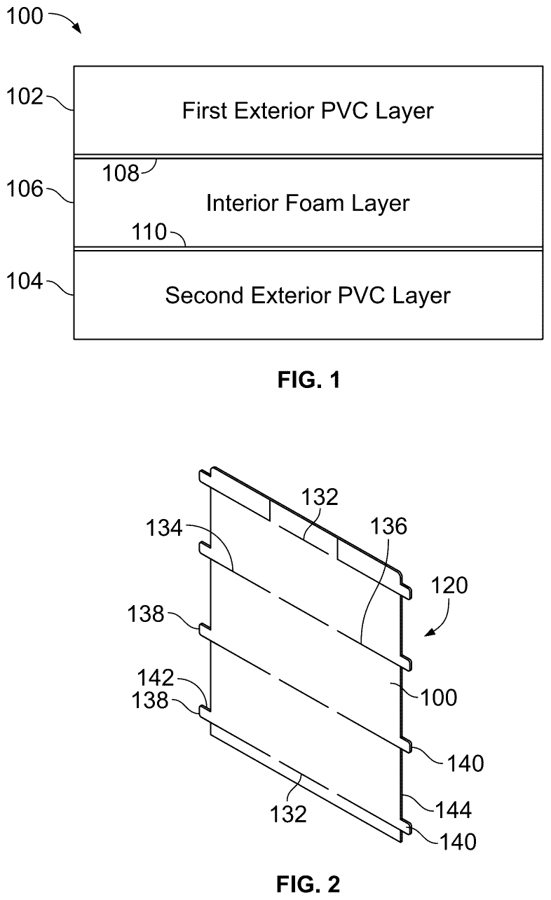

FIG. 1 illustrates a box diagram of a board 100, according to an example of the present disclosure. In at least one example, the board 100 is configured to be used to form a product holder system. The board 100 includes a first exterior polyvinyl chloride (PVC) layer 102, a second exterior PVC layer 104, and an interior foam layer 106 having a first surface 108 and a second surface 110 opposite from the first surface 108. For example, the first surface 108 can be a top surface, and the second surface 110 can be a bottom surface, or vice versa. As another example, the first surface 108 can be a front surface, and the second surface 110 can be a rear surface, or vice versa. The interior foam layer 106 is sandwiched between the first exterior PVC layer 102 and the second exterior PVC layer 104.

In at least one example, the interior foam layer 106 is formed of a closed cell foam. As another example, the interior foam layer 106 is formed of an open cell foam.

The first exterior PVC layer 102 is coupled to (for example, disposed on) the first surface 108 of the interior foam layer 106. The second exterior PVC layer 104 is coupled to the second surface 110 of the interior foam layer 106. In at least one example, the first exterior PVC layer 102 is adhesively secured to the first surface 108, such as through one or more of an epoxy, a resin, and/or the like. Similarly, the second exterior PVC layer 104 is adhesively secured to the second surface 110, such as through one or more of an epoxy, a resin, and/or the like. As a further example, adhesive can be applied to the first surface 108 and the second surface 110. After the adhesive is applied to the first surface 108 and the second surface 110, the first exterior PVC layer 102 and the second exterior PVC layer 104 are disposed on the first surface 108 and the second surface 110, respectively, with the adhesives forming bonds. After the first exterior PVC layer 102 and the second exterior PVC layer 104 are secured to the first surface 108 and the second surface 110, respectively, the board 100 can then be cured, such as within an oven or other heating system, to strengthen bonds between the interior foam layer 106 and the first exterior PVC layer 102 and the second exterior PVC layer 104. Optionally, the board 100 is not cured.

As noted, the interior foam layer 106 provides a stiff inner layer sandwiched between the first exterior PVC layer 102 and the second exterior PVC layer 104. The exterior PVC layers 102 and 104 can be bent and folded without being heated.

In at least one example, the board 100 provides a foam board construction material printed and cut to create components that are assembled together to form product holder systems. The board 100 is not corrugated. The board 100 (and other boards 100) can be formed and shipped as a flat panel, and subsequently cut, sized, shaped, folded, and/or the like to assemble the product holder systems. It has been found that the board 100 having the first exterior PVC layer 102 and the second exterior PVC layer 104 coupled to the interior foam layer 106 provides a resilient, robust structure that can be easily and efficiently fashioned, such as through cutting and folding, to form a system, such as a product holder system, which is strong and durable after such fashioning.

The board 100 is bendable and foldable. The first exterior PVC layer 102 and the second exterior PVC layer 104 enable flat shipping. Further, the first exterior PVC layer 102 and the second PVC layer 104 are durable, and increase lifespan of the board 100. For example, the exterior PVC layers 102 and 104 resist cracking and breaking while providing a protective shield over the interior foam layer 106. In contrast to corrugated panels, the board 100 is impervious to water. Additionally, the board 100 has a high tensile strength. Further, unlike other known boards, the board 100 does not require heat bending to prevent cracking. Also, in contrast to other known boards, the board 100 is substantially less costly to manufacture.

A printer can be used to directly print text, graphics, and the like directly on the board 100. The interior foam layer 106 can be custom colored. Graphics, text, coloring, and the like can be printed on the board 100, such as via 4 color-process direct litho-printing. An exterior clear coating can be applied to protect printed surfaces. Each board 100 can be die-cut to a custom shape and size. The boards 100 can be chisel cut with “V” and “U” shaped cuts for 90° folding and channel inserting to create display walls, shelves and header cards. Shelf locking mechanisms can be used to eliminate the need for glue and other extraneous accessories like screws and pins.

Multiple boards 100 are assembled together to form product holder systems having a premium look and feel with all the benefits of corrugated components. The systems including the board 100 as shown and described offer improved brand image with better printability, simplicity and flexibility than corrugated displays. The board 100 can be manufactured in low- to mid-quantities at price points competitive with higher volumes. The simplicity of the design allows the displays to ship flat, saving space and money, while being easy to assemble. The boards 100 can be modularly assembled to form display systems of different shapes and sizes.

In at least one example, a manufacturing process starts by providing a board 100. For example, the board 100 can be provided in a desired standard size. Decals can be printed directly on the board 100, such as on exterior surfaces of one or both of the first exterior PVC layer 102 and/or the second exterior PVC layer 104. That is, the first exterior PVC layer 102 and the second exterior PVC layer 104 can be provided with graphics, texts, decals, and/or the like.

The first exterior PVC layer 102 and the second PVC layer 104 can be adhesively secured to the interior foam layer 106, such as via glue, thereby providing the board 100. The board 100 can then be cut by a computer numerical control (CNC) cutting machine to cut into a shape as desired. Excess portions can be trimmed from the board 100, as desired.

FIG. 2 illustrates an isometric front view of a wall panel 120, according to an example of the present disclosure. The wall panel 120 is formed from a board 100, and is sized and cut to a desired shape. As shown, the wall panel 120 is flat, and can be easily shipped. The wall panel 120 is configured to be bent and folded to a desired shape after shipping.

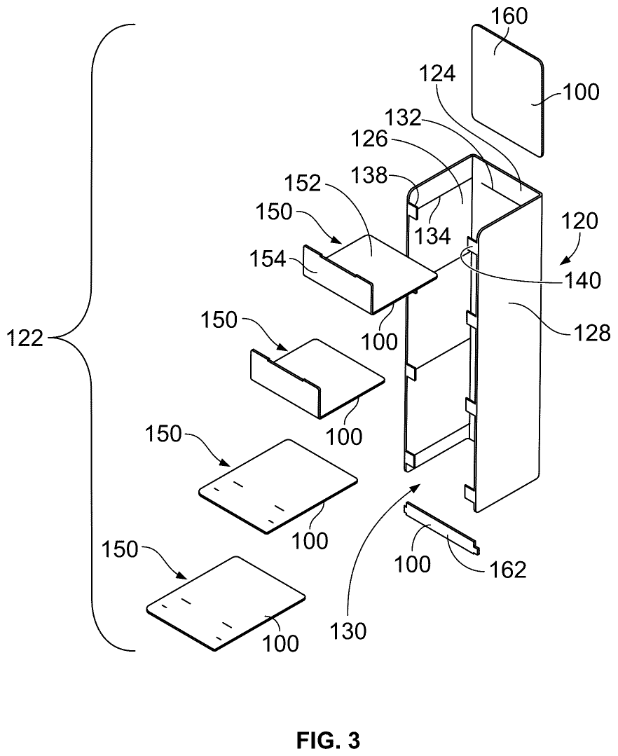

FIG. 3 illustrates an isometric front exploded view of a product holder system 122, according to an example of the present disclosure. As shown, the wall panel 120 is bent and shaped to provide a rear wall 124 connected to a first lateral wall 126 and a second lateral wall 128 opposite from the first lateral wall 126. An interior chamber 130 is defined between the rear wall 124, the first lateral wall 126, and the second lateral wall 128.

Referring to FIGS. 2 and 3, the wall panel 120 includes rear slots 132, first lateral slots 134, and second lateral slots 136. Additionally, exterior tabs 138 and 140 outwardly extend from exterior edges 142 and 144 of the wall panel 120. The wall panel 120 can include more or fewer rear slots 132, first lateral slots 134, second lateral slots 136, and exterior tabs 138 and 140 than shown.

After the wall panel 120 is fashioned to provide the rear wall 124, the first lateral wall 126, and the second lateral wall 128, the exterior tabs 138 are inwardly folded to be in a plane that is parallel with the rear wall 124. The rear slots 132, the first lateral slots 134, the second lateral slots 136, the exterior tabs 138 and 140 cooperate to retain shelves 150, each of which is formed from a board 100, and fashioned to a desired shape, such as can include a platform 152 and a front rail 154 upwardly extending from a front edge of the platform 152.

The product holder system 122 can also include a header 160 formed of a board 100, which can upwardly extend from a rear portion of a top shelf 150. Additionally, the product holder system 122 can also include a base rail 162, also formed of a board 100, at a lower portion.

The product holder system 122 shown in FIG. 3 is merely exemplary. The product holder system 122 can have more or fewer components (such as shelves 150) than shown. Further, the various components can be sized and shaped differently than shown. The various components are formed from boards 100, which are fashioned to desired shapes and sizes.

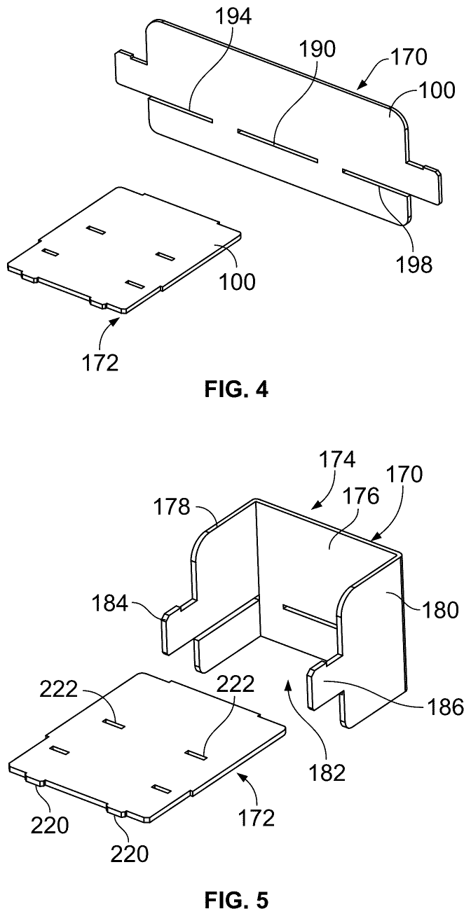

FIG. 4 illustrates an isometric front exploded view of a wall panel 170 and a shelf panel 172, according to an example of the present disclosure. Each of the wall panel 170 and the shelf panel 172 is formed of a board 100, which is cut and sized as desired. Tabs and slots are formed in the wall panel 170 and the shelf panel 172.

FIG. 5 illustrates an isometric front exploded view of a retaining shroud 174 separated from the shelf panel 172, according to an example of the present disclosure. The retaining shroud 174 is formed by the wall panel 170 being fashioned to provide a rear wall 176, a first lateral wall 178, and a second lateral wall 180 to provide a chamber 182 therebetween. Tabs 184 and 186 extend forwardly from the first lateral wall 178 and the second lateral wall 180, respectively.

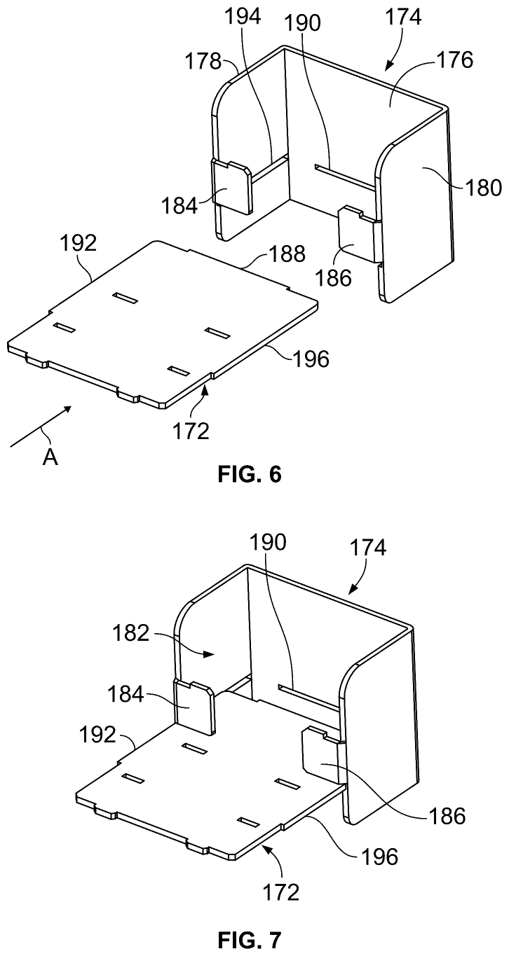

FIG. 6 illustrates an isometric front exploded view of inwardly-bent tabs 184 and 186 of the retaining shroud 174, according to an example of the present disclosure. The tabs 184 and 186 are inwardly bent to be in a plane that is parallel with the rear wall 176.

FIG. 7 illustrates an isometric front view of the shelf panel 172 connecting to the retaining shroud, according to an example of the present disclosure. Referring to FIGS. 6 and 7, the shelf panel 172 is inserted into the chamber 182 in the direction of arrow A underneath the tabs 184 and 186 so that a rear tab 188 of the shelf panel 172 fits into a rear slot 190 of the rear wall 176, a first lateral tab 192 of the shelf panel 172 fits into a first lateral slot 194 of the first lateral wall 178, and a second lateral tab 196 fits into a second lateral slot 198 (shown in FIG. 4) of the second lateral wall 180.

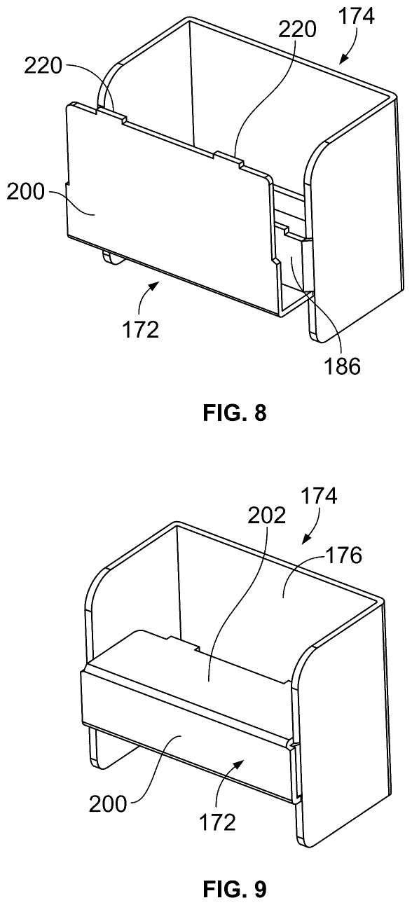

FIG. 8 illustrates an isometric front view of the shelf panel 172 having a front portion 200 upwardly folded, according to an example of the present disclosure. The front portion 200 is upwardly folded in front of the tabs 184 and 186.

FIG. 9 illustrates an isometric front view of the shelf panel 172 having a top portion 202 rearwardly folded, according to an example of the present disclosure. The top portion 202 is rearwardly folded toward the rear wall 176 of the retaining shroud 174.

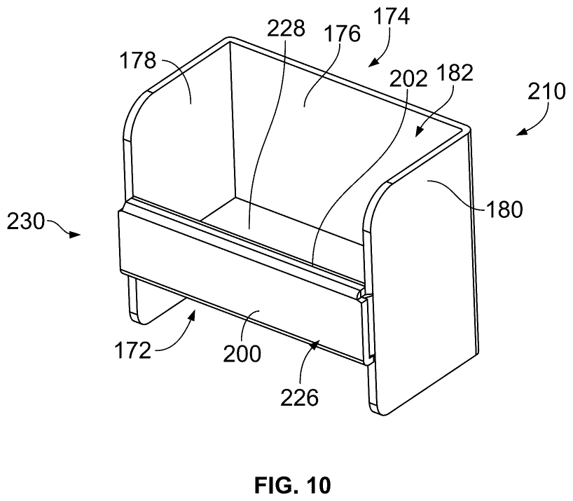

FIG. 10 illustrates an isometric front view of a product holder system 210, according to an example of the present disclosure. The top portion 202 is folded downwardly so that tabs 220 of the shelf panel 172 are retained within inboard slots 222 of the shelf panel 172, thereby forming a secure front barrier rail 226. Product can then be placed and retained within the chamber 182 on a platform 228 formed by an inboard portion of the shelf panel 172, between the rear wall 176, the first lateral wall 178, the second lateral wall 180, and the front barrier rail 226, which forms a retaining shelf 230.

FIG. 10 shows the product holder system 210 having one retaining shelf 230 for displaying product. The product holder system 210 can have additional retaining shelves. Further, the product holder system 210 can provide a retaining shelf 230 that can be modularly inserted into a larger retainer formed of a board 100 that is configured to retain additional retaining shelves.

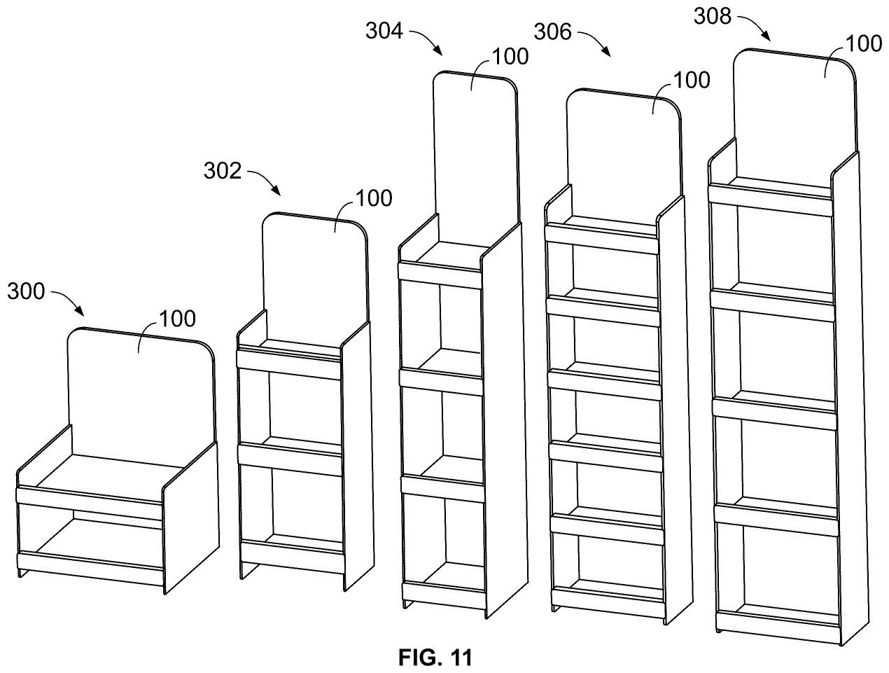

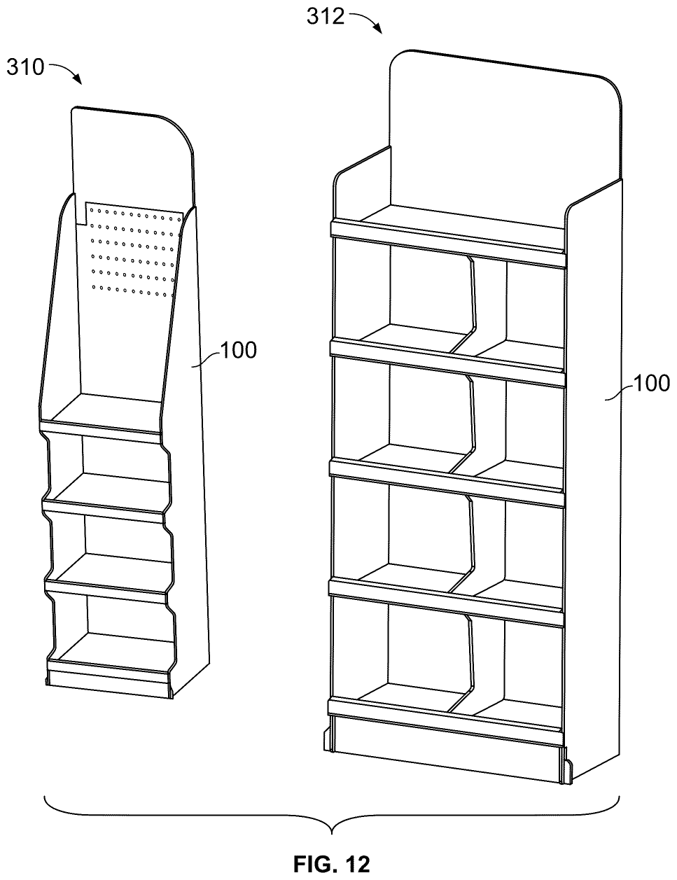

FIGS. 11 and 12 illustrate an isometric front view of product holder systems 300, 302, 304, 306, 308, 310, and 312, according to examples of the present disclosure. Each of the product holder systems 300-312 is formed from one or more boards 100, which are sized, shaped, and fashioned, as desired. The product holder systems 300-312 can be sized and shaped differently than shown. The product holder systems 300-312 shown in FIGS. 11 and 12 are merely exemplary, and are not limiting.

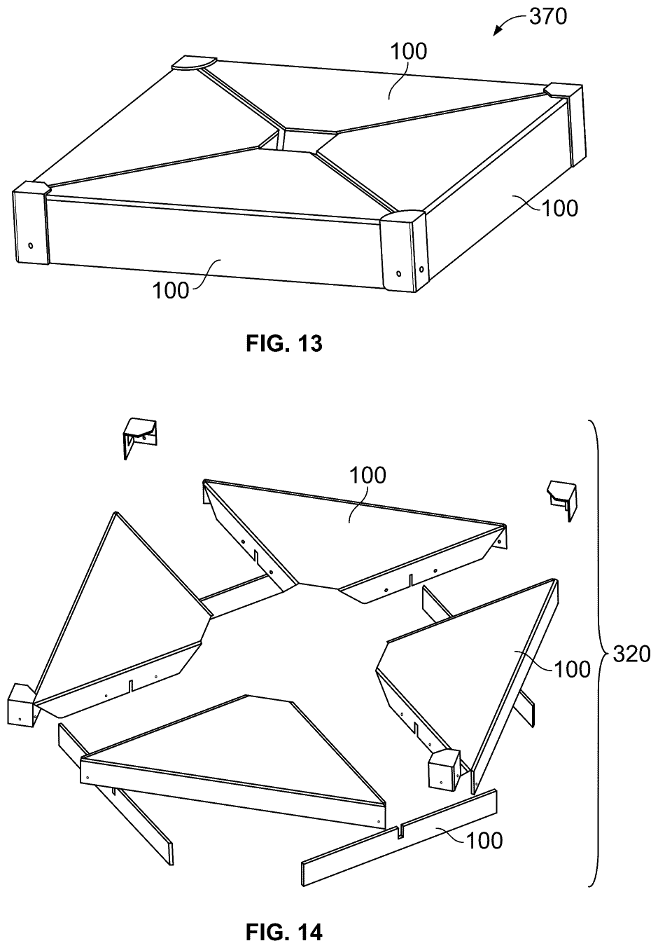

FIG. 13 illustrates an isometric top view of a base 320, according to an example of the present disclosure. FIG. 14 illustrates an isometric top exploded view of the base 320 of FIG. 13. The base 320 includes various components formed of boards 100, which are sized, shaped, and fashioned, as desired. The base 320 can provide a product holder system, or a portion of a product holder system. The base 320 shown in FIGS. 13 and 14 is merely exemplary, and not limiting.

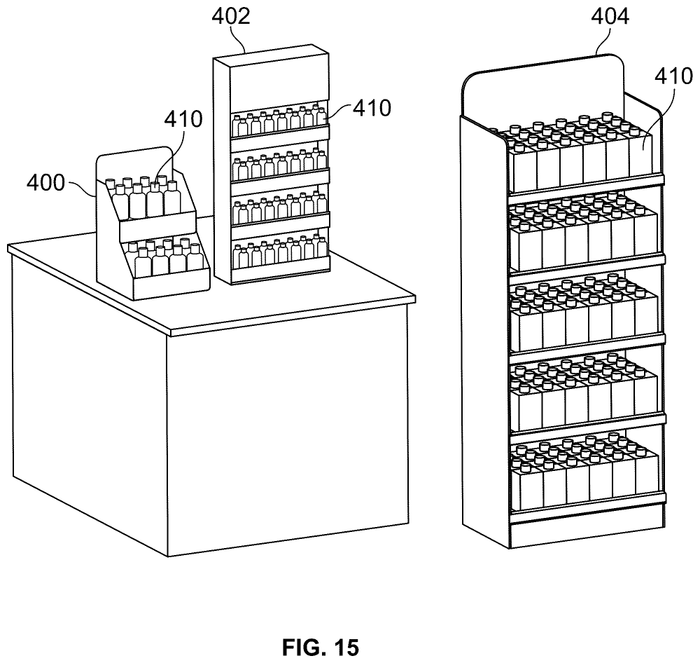

FIG. 15 illustrates an isometric front view of product holder systems 400, 402, and 404 retaining products 410, according to an example of the present disclosure. The displays 400-402 are formed of boards 100, as described herein. The products 410 can be beverage bottles or cans, boxes or bags of food items, materials, or the like, etc.

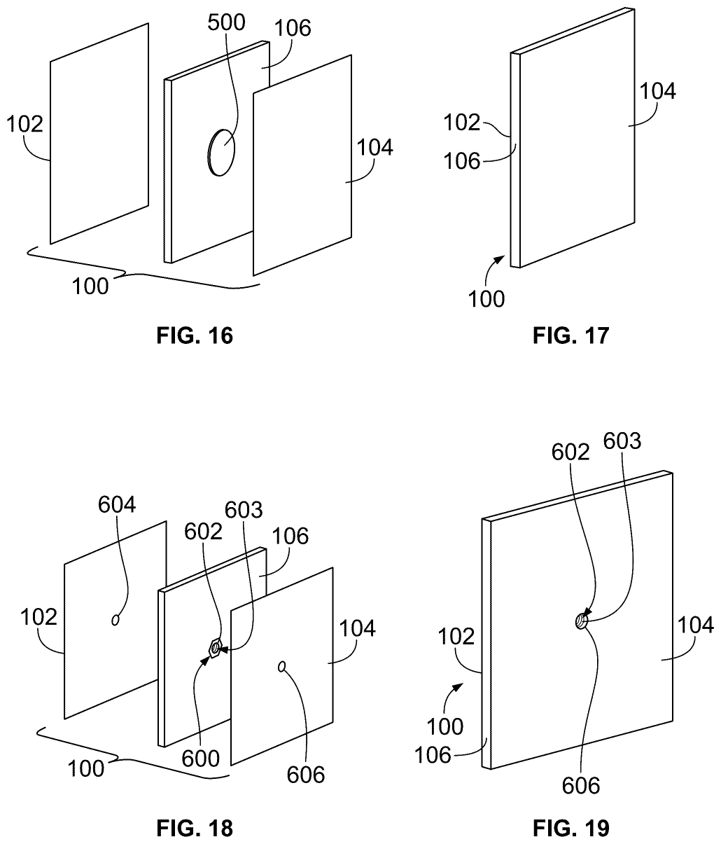

FIG. 16 illustrates an isometric exploded view of a board 100, according to an example of the present disclosure. FIG. 17 illustrates an isometric view of the board of FIG. 16. Referring to FIGS. 16 and 17, the board 100 can include an additional component, such as a near field communication (NFC) device 500, such as a radio frequency identification (RFID) tag. In at least one example, the NFC device 500 is secured to a surface of the interior foam layer 106, such as by an adhesive. As another example, a recess can be formed in the interior foam layer 106, and the NFC device 500 can be received and retained by the recess. The NFC device 500 can be sandwiched between the second exterior PVC layer 104 (or optionally, the first exterior PVC layer 102), and the interior foam layer 106.

FIG. 18 illustrates an isometric exploded view of a board 100, according to an example of the present disclosure. FIG. 19 illustrates an isometric view of the board of FIG. 18. Referring to FIGS. 18 and 19, a channel 600 is formed through the interior foam layer 106. The channel 600 receives and retains a nut 602, which includes a central threaded passage 603 that is configured to threadably couple to a threaded shaft of a fastener, such as a bolt or screw. The first exterior PVC layer 102 and the second exterior PVC layer 104 include passages 604 and 606, respectively, that axially align with the central threaded passage 603 of the nut 602, thereby allowing the fastener to easily secure to the board 100. In at least one example, the board 100 includes the NFC device 500 (shown in FIGS. 16 and 17), and the nut 602 (shown in FIGS. 18 and 19).

Referring to FIGS. 1-19, various structures can be coupled to the boards 100, as shown in FIGS. 1-19. For example, NFC devices can be secured to outer portions of the boards 100, embedded within the boards 100, or the like. As another example, fasteners can be secured to the boards 100. Plastic product pushers, peg hooks, or the like can be secured to the boards 100. The product holder systems and boards can include acrylic facings.

The product holder systems shown and described can be sized, shaped, and configured differently than shown. The product holder systems can include floor supports formed of one or more boards. The floor supports rest on a surface, such as a floor.

Product holder systems are formed of one or more boards 100, which can be fashioned (for example, sized, shaped, cut, folded, and the like) as desired. The product holder systems shown and described are exemplary, and not limiting. Additionally, examples of the present disclosure provide product holder systems that are impervious to water.

Further, the disclosure comprises examples according to the following clauses:

Clause 1. A board configured to form one or more portions of a product holder system, the board comprising:
a first exterior polyvinyl chloride (PVC) layer;
a second exterior PVC layer; and
an interior foam layer having a first surface and a second surface opposite from the first surface, wherein the first PVC layer is coupled to the first surface, and wherein the second PVC layer is coupled to the second surface.

Clause 2. The board of Clause 1, wherein the first PVC layer is adhesively secured to the first surface, and wherein the second PVC layer is adhesive secured to the second surface.

Clause 3. The board of Clauses 1 or 2, wherein the board is configured to be formed as a flat panel.

Clause 4. The board of any of Clauses 1-3, wherein the board is configured to be cut, sized, shaped, and folded to form the one or more portions of the product holder system.

Clause 5. The board of Clause 4, wherein the board is configured to be cut, sized, shaped, and folded without being heated.

Clause 6. The board of any of Clauses 1-5, wherein none of the first exterior PVC layer, the second exterior PVC layer, or the interior foam layer is corrugated.

Clause 7. The board of any of Clauses 1-6, wherein one or both of the first exterior PVC layer or the second exterior PVC layer includes one or both of text or graphics printed thereon.

Clause 8. The board of any of Clauses 1-7, further comprising one or more walls, tabs, and slots, wherein the one or more walls and the tabs include the first exterior PVC layer, the second exterior PVC layer, and the interior foam layer.

Clause 9. A method of forming a product holder system, the method comprising:
coupling a first exterior polyvinyl (PVC) layer to a first surface of an interior foam layer;
coupling a second exterior PVC layer to a second surface of the interior foam layer, wherein the second surface is opposite from the first surface;
forming a board by the first PVC layer and the second PVC layer coupled to the interior foam layer; and
forming one or more portions of the product holder system with the board.

Clause 10. The method of Clause 9, wherein said coupling the first PVC layer comprises adhesively securing the first PVC layer to the first surface, and wherein said coupling the second PVC layer comprises adhesively securing the second PVC layer to the second surface.

Clause 11. The method of Clauses 9 or 10, wherein said forming the board comprises forming the board as a flat panel.

Clause 12. The method of any of Clauses 9-11, further comprising cutting, sizing, shaping, and folding the board to form the one or more portions of the product holder system.

Clause 13. The method of Clause 12, wherein said cutting, sizing, shaping, and folding occurs without heating.

Clause 14 The method of any of Clauses 9-13, wherein none of the first exterior PVC layer, the second exterior PVC layer, or the interior foam layer is corrugated.

Clause 15. The method of any of Clauses 9-14, further comprising printing one or both of text or graphics on one or both of the first exterior PVC layer or the second exterior PVC layer.

Clause 16. The method of any of Clauses 9-15, wherein the board comprises one or more walls, tabs, and slots.

Clause 17. A product holder system comprising:
one or more shelves formed by one or more boards, wherein the one or more boards include:
   a first exterior polyvinyl chloride (PVC) layer;
   a second exterior PVC layer; and
   an interior foam layer having a first surface and a second surface opposite from the first surface, wherein the first PVC layer is coupled to the first surface, and wherein the second PVC layer is coupled to the second surface.

Clause 18. The product holder system of Clause 17, wherein the first PVC layer is adhesively secured to the first surface, and wherein the second PVC layer is adhesive secured to the second surface.

Clause 19. The product holder system of Clauses 17 or 18, wherein the one or more boards are configured to be formed as a flat panel, wherein the one or more boards are configured to be cut, sized, shaped, and folded to form the one or more shelves, wherein the one or more boards are configured to be cut, sized, shaped, and folded without being heated, and wherein none of the first exterior PVC layer, the second exterior PVC layer, or the interior foam layer is corrugated.

Clause 20. The product holder system of any of Clauses 17-19, wherein the one or more board further include one or more walls, tabs, and slots, and wherein the one or more walls and the tabs include the first exterior PVC layer, the second exterior PVC layer, and the interior foam layer.

As described herein, examples of the present disclosure provide an improved method of forming a product holder system. Further, examples of the present disclosure provide resilient and robust product holder systems.

While various spatial and directional terms, such as top, bottom, lower, mid, lateral, horizontal, vertical, front and the like can be used to describe examples of the subject disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the parameters of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

1. A board configured to form one or more portions of a product holder system, the board comprising:
a first exterior polyvinyl chloride (PVC) layer;
a second exterior PVC layer; and
an interior foam layer having a first surface and a second surface opposite from the first surface, wherein the first PVC layer is coupled to the first surface, and wherein the second PVC layer is coupled to the second surface.

2. The board of claim 1, wherein the first PVC layer is adhesively secured to the first surface, and wherein the second PVC layer is adhesive secured to the second surface.

3. The board of claim 1, wherein the board is configured to be formed as a flat panel.

4. The board of claim 1, wherein the board is configured to be cut, sized, shaped, and folded to form the one or more portions of the product holder system.

5. The board of claim 4, wherein the board is configured to be cut, sized, shaped, and folded without being heated.

6. The board of claim 1, wherein none of the first exterior PVC layer, the second exterior PVC layer, or the interior foam layer is corrugated.

7. The board of claim 1, wherein one or both of the first exterior PVC layer or the second exterior PVC layer includes one or both of text or graphics printed thereon.

8. The board of claim 1, further comprising one or more walls, tabs, and slots, wherein the one or more walls and the tabs include the first exterior PVC layer, the second exterior PVC layer, and the interior foam layer.

9. The board of claim 1, further comprising a near field communication device secured to the interior foam layer.

10. The board of claim 1, further comprising a nut secured to the interior foam layer.

11. A method of forming a product holder system, the method comprising:
coupling a first exterior polyvinyl (PVC) layer to a first surface of an interior foam layer;
coupling a second exterior PVC layer to a second surface of the interior foam layer, wherein the second surface is opposite from the first surface;
forming a board by the first PVC layer and the second PVC layer coupled to the interior foam layer; and
forming one or more portions of the product holder system with the board.

12. The method of claim 11, wherein said coupling the first PVC layer comprises adhesively securing the first PVC layer to the first surface, and wherein said coupling the second PVC layer comprises adhesively securing the second PVC layer to the second surface.

13. The method of claim 11, wherein said forming the board comprises forming the board as a flat panel.

14. The method of claim 11, further comprising cutting, sizing, shaping, and folding the board to form the one or more portions of the product holder system.

15. The method of claim 13, wherein said cutting, sizing, shaping, and folding occurs without heating.

16. The method of claim 11, wherein none of the first exterior PVC layer, the second exterior PVC layer, or the interior foam layer is corrugated.

17. The method of claim 11, further comprising printing one or both of text or graphics on one or both of the first exterior PVC layer or the second exterior PVC layer.

18. The method of claim 11, wherein the board comprises one or more walls, tabs, and slots.

19. A product holder system comprising:
one or more shelves formed by one or more boards, wherein the one or more boards include:
a first exterior polyvinyl chloride (PVC) layer;
a second exterior PVC layer; and
an interior foam layer having a first surface and a second surface opposite from the first surface, wherein the first PVC layer is coupled to the first surface, and wherein the second PVC layer is coupled to the second surface.

20. The product holder system of claim 19, wherein the first PVC layer is adhesively secured to the first surface, and wherein the second PVC layer is adhesive secured to the second surface.

21. The product holder system of claim 19, wherein the one or more boards are configured to be formed as a flat panel, wherein the one or more boards are configured to be cut, sized, shaped, and folded to form the one or more shelves, wherein the one or more boards are configured to be cut, sized, shaped, and folded without being heated, and wherein none of the first exterior PVC layer, the second exterior PVC layer, or the interior foam layer is corrugated.

22. The product holder system of claim 19, wherein the one or more board further include one or more walls, tabs, and slots, and wherein the one or more walls and the tabs include the first exterior PVC layer, the second exterior PVC layer, and the interior foam layer.
